(19) United States
(12) Patent Application Publication
(10) Pub. No.: US 2026/0361617 A1
(43) Pub. Date: Nov. 12, 2026

(54) DISTRIBUTION DEVICE, DISTRIBUTION PROGRAM, AND ANOMALY NOTIFICATION SYSTEM

(71) Applicant: NTT, Inc., Tokyo (JP)

(72) Inventors: Nobuhiro CHIBA, Musashino-shi, Tokyo (JP); Naoto FUJIKI, Musashino-shi, Tokyo (JP); Yukio NAGAFUCHI, Musashino-shi, Tokyo (JP); Takaaki KOYAMA, Musashino-shi, Tokyo (JP); Yoshiaki NAKAJIMA, Musashino-shi, Tokyo (JP); Ryota SATO, Musashino-shi, Tokyo (JP)

(73) Assignee: NTT, Inc., Tokyo (JP)

(21) Appl. No.: 19/486,962

(22) PCT Filed: May 30, 2023
(86) PCT No.: PCT/JP2023/020029

§ 371 Date: Nov. 24, 2025

(51) Int. Cl. H04L 41/00; H04L 41/0631

(52) U.S. Cl. CPC H04L 41/20; H04L 41/0645

(57) ABSTRACT

A distribution device includes processing circuitry configured to acquire data of equipment included in a network to be monitored, estimate communication destinations of the equipment using the data of the equipment acquired, collect address information corresponding to the communication destinations of the equipment estimated, create information regarding normal communication for each network to be monitored using the data of the equipment acquired and the address information corresponding to the communication destinations of the equipment collected, and distribute the information regarding the normal communication created to the network to be monitored.

### TECHNICAL FIELD

The present invention relates to a distribution device, a distribution program, and an abnormality notification system.

### BACKGROUND ART

In related art, in a network state analysis technique, there is a technique of learning ordinary communication for a certain period and determining that communication is abnormal communication when the communication is performed to a destination IP address different from that at the time of learning.

### CITATION LIST

### Non Patent Literature

Non Patent Literature 1: An Experimental Study on Name Resolution History Basis Abnormal Detection and Blocking Using SDN and DNS RPZ, (Institute of Electronics, Information and Communication Engineers), [Search on May 29, 2023], Internet (https://eprints.lib.hokudai.ac.jp/dspace/handle/2115/86960) Non Patent Literature 2: Study for Detecting Bot-Infected PC based on Behavior of DNS Query, [Search on May 29, 2023], Internet (https://www.iwsec.org/mws/2008/manuscript/1008.pdf) Non Patent Literature 3: Real-time Malicious DNS Query Classification System by Machine Learning, [Search on May 29, 2023], Internet (https://repository.dl.itc.u-tokyo.ac.jp/record/51888/files/48176414.pdf)

### SUMMARY OF INVENTION

### Technical Problem

In the related art, there is a problem that it may not be easy to prepare information related to normal communication corresponding to a network to be monitored. For example, in the related art, overdetection occurs in which normal communication different from usual (such as a case where fully qualified domain name (FQDN) is the same, but IP addresses are different) is detected as abnormal. In order to prevent occurrence and notification of this overdetection, for example, it is necessary to prepare list information of IP addresses corresponding to the FQDN. However, in an environment where there are many networks to be monitored, it is inefficient to create and set the list information of the IP addresses corresponding to the FQDN in consideration of communication destinations of equipment included in each network.

The present invention has been made in view of the above, and an object of the present invention is to provide a distribution device, a distribution program, and an abnormality notification system that prepare information regarding normal communication corresponding to a network to be monitored.

### Solution to Problem

In order to solve the above-described problem and achieve the object, a distribution device of the present invention includes: an acquisition unit that acquires data of equipment included in a network to be monitored; an estimation unit that estimates communication destinations of the equipment using the data of the equipment acquired by the acquisition unit; a collection unit that collects address information corresponding to the communication destinations of the equipment estimated by the estimation unit; a creation unit that creates information regarding normal communication for each network to be monitored using the data of the equipment acquired by the acquisition unit and the address information corresponding to the communication destinations of the equipment collected by the collection unit; and a distribution unit that distributes the information regarding the normal communication created by the creation unit to the network to be monitored.

### Advantageous Effects of Invention

According to the present invention, it is possible to easily prepare information related to normal communication corresponding to a network to be monitored.

### BRIEF DESCRIPTION OF DRAWINGS

FIG. 1 is a table for explaining a problem in related art.

FIG. 2 is a block diagram illustrating an example of a configuration of an abnormality notification system according to an embodiment.

FIG. 3 is a block diagram illustrating an example of a configuration of a distribution device according to the embodiment.

FIG. 4 is a block diagram illustrating an example of a configuration of a notification device according to the embodiment.

FIG. 5 is a view illustrating outline of processing by the distribution device according to the embodiment.

FIG. 6 is a view illustrating outline of processing by the distribution device according to the embodiment.

FIG. 7 is a view illustrating outline of processing by the distribution device according to the embodiment.

FIG. 8 is a view illustrating outline of processing by the notification device according to the embodiment.

FIG. 9 is a view illustrating outline of processing by the notification device according to the embodiment.

FIG. 10 is a flowchart indicating an example of flow of the processing by the distribution device according to the embodiment.

FIG. 11 is a flowchart indicating an example of flow of the processing by the notification device according to the embodiment.

FIG. 12 is a view illustrating an example of a computer that executes a distribution program.

### DESCRIPTION OF EMBODIMENTS

Hereinafter, an embodiment of a distribution device, a distribution program, and an abnormality notification system according to the present application will be described in detail with reference to the drawings. Note that the present invention is not limited by the embodiment. Furthermore, the same elements are denoted by the same reference signs in the description of the drawings, and the overlapping description will be omitted.

### Introduction

In related art, there is an abnormal communication detection system that identifies communication different from ordinary communication as abnormal communication. In such an abnormal communication detection system, while unknown abnormal communication different from ordinary communication can be correctly identified as abnormal, overdetection may occur in which normal communication different from ordinary communication is erroneously identified as abnormal communication.

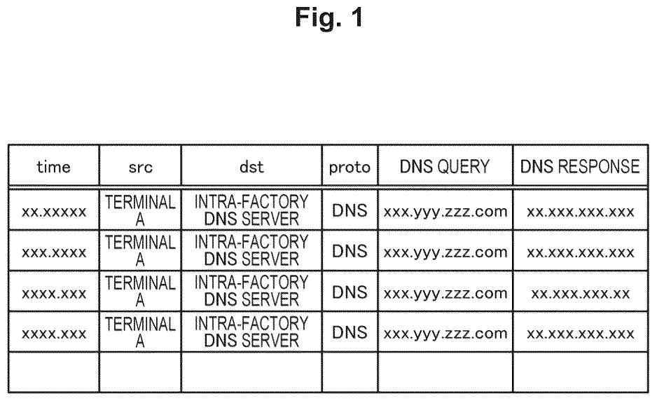

For example, as illustrated in FIG. 1, even in communication addressed to the same FQDN, different IP addresses may be obtained by name resolution of a domain name system (DNS). In particular, in a case where a contents delivery network (CDN) is used, an IP address corresponding to the FQDN may be frequently changed.

In addition, in the example illustrated in FIG. 1, in a case where learning of an IP address corresponding to a terminal A and a DNS response is not performed, overdetection occurs each time the terminal A performs communication with each IP address although the communication is performed to the same FQDN. In addition, FIG. 1 illustrates an example of only the terminal A, but in a case where the number of terminals increases, occurrence of overdetection exponentially increases.

If a large number of overdetections occur, it takes a lot of time to check whether the communication is really abnormal, which is inefficient, and in a case where truly abnormal communication occurs, there is an increased risk that handling of the abnormal communication is delayed or omitted. Thus, in order to discriminate between normal communication and abnormal communication, information on IP addresses corresponding to the same FQDN is required.

Here, equipment included in the network, software installed in the equipment, and the like, are different for each network to be monitored, and thus, it is necessary to prepare information of IP addresses corresponding to the same FQDN for each network to be monitored in order to determine abnormal communication. However, in an environment where a large number of networks exist, it is inefficient to create and set list information of the IP addresses corresponding to the same FQDN in consideration of communication destinations of the equipment included in each network.

Thus, a distribution device 100 performs the following processing. First, the distribution device 100 acquires data of equipment included in the network to be monitored. Next, the distribution device 100 estimates communication destinations of the equipment using the data of the equipment. Subsequently, the distribution device 100 collects IP addresses corresponding to communication destinations. Thereafter, the distribution device 100 creates information regarding normal communication for each network to be monitored from the data of the equipment and the IP addresses corresponding to the communication destinations of the equipment. Then, the distribution device 100 distributes information regarding normal communication to the network to be monitored.

As a result, the distribution device 100 can prepare information regarding normal communication for each network to be monitored. For example, the distribution device 100 creates a list of the FQDN and IP addresses as a master list and distributes the master list to the network to be monitored, thereby enabling efficient operation of a plurality of abnormal communication detection systems. In addition, for example, the distribution device 100 automatically distributes an update result of the master list of the FQDN and the IP addresses to the network to be monitored, thereby enabling operation of a plurality of abnormal communication detection systems always by the latest list of the FQDN and the IP addresses without trouble.

In addition, for example, the distribution device 100 grasps equipment and a software configuration that are being used in the network to be monitored and then distributes a list of FQDN and IP addresses corresponding to the network, so that it is possible to efficiently detect abnormal communication while preventing overdetection even in a network in which various kinds of equipment are mixed.

### [Configuration of Abnormality Notification System]

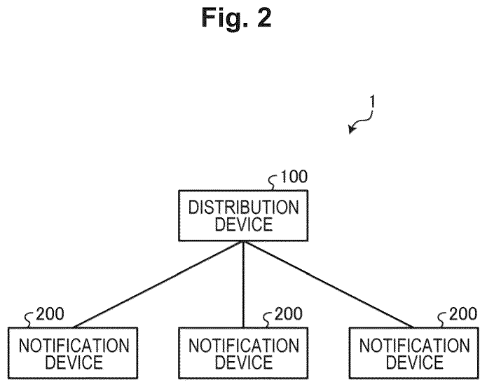

Next, a configuration of an abnormality notification system 1 will be described with reference to FIG. 2. The abnormality notification system 1 is a system that makes a notification of an abnormality of communication detected by an external system such as an abnormality detection system. As illustrated in FIG. 2, the abnormality notification system 1 includes the distribution device 100 and a notification device 200. Outline of processing of each device will be described below.

The distribution device 100 collects address information of communication destinations of equipment estimated from data of the equipment included in the network to be monitored, creates information regarding normal communication for each network to be monitored using the data of the equipment and the address information corresponding to the communication destinations, and distributes the information regarding the normal communication to the network to be monitored.

The notification device 200 is disposed in each network to be monitored, acquires information on abnormal communication detected by an external system such as an abnormality detection system, determines whether the information on abnormal communication corresponds to the information on normal communication distributed from the distribution device 100, and outputs the information on abnormal communication and the information on normal communication to make a notification in a case where the distribution device 100 determines it corresponds.

Note that the abnormality detection system exemplified as the external system is a system that detects an abnormality in communication and may include the abnormality notification system 1 in the present embodiment.

### [Configuration of Distribution Device]

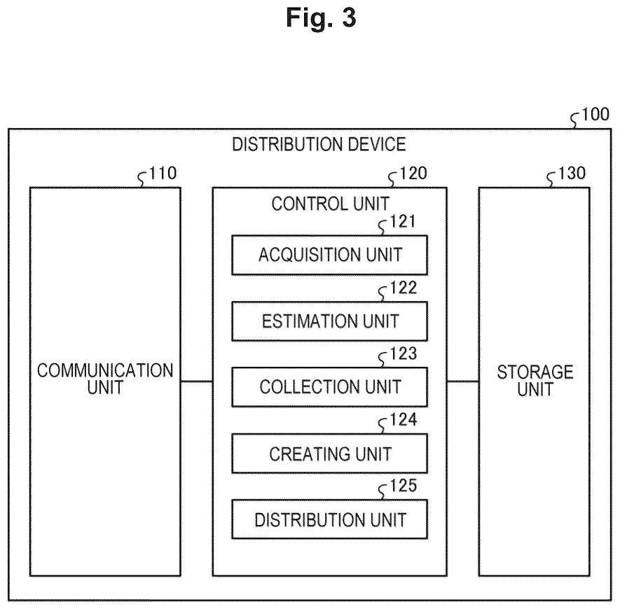

Next, a configuration of the distribution device 100 will be described with reference to FIG. 3. As illustrated in FIG. 3, the distribution device 100 includes a communication unit 110, a control unit 120, and a storage unit 130. Note that a plurality of devices may hold these units in a distributed manner. Hereinafter, processing by each of these units will be described.

The communication unit 110 is implemented by a network interface card (NIC), or the like, and enables communication between the external device and the control unit 120 via an electrical communication line such as a local area network (LAN) or the Internet. For example, the communication unit 110 enables communication between the external device and the control unit 120.

The storage unit 130 is implemented by a semiconductor memory element such as a random access memory (RAM) or a flash memory, or a storage device such as a hard disk or an optical disc. The information stored in the storage unit 130 includes, for example, data of equipment, information regarding normal communication, and other information necessary for distribution of information regarding normal communication. Here, the data of the equipment is data for managing the equipment included in the network to be monitored, and includes data held by a package management system included in the equipment, data held by a configuration management system that integrally manages the equipment, and the like. In addition, the data of the equipment includes information on a network to which the equipment belongs, terminal information of the equipment, information on software installed in the equipment, and the like. The information regarding the normal communication includes the FQDN of normal communication destinations, the information on the IP addresses corresponding to the FQDN of the normal communication destinations, and the like. Note that the information stored in the storage unit 130 is not limited to the examples described above.

The control unit 120 is implemented using a central processing unit (CPU), a network processor (NP), a field programmable gate array (FPGA), or the like, and executes a processing program stored in a memory. As illustrated in FIG. 3, the control unit 120 includes an acquisition unit 121, an estimation unit 122, a collection unit 123, a creation unit 124, and a distribution unit 125. Hereinafter, each unit included in the control unit 120 will be described.

The acquisition unit 121 acquires data of equipment included in the network to be monitored. For example, the acquisition unit 121 acquires, as the data of the equipment included in the network to be monitored, data of target equipment, data held in a package management system included in the target equipment, and data held in a configuration management system that integrally manages the target equipment. Here, the data of the equipment acquired by the acquisition unit 121 includes, for example, terminal information of the equipment, information that can be used for estimation of communication destinations of the equipment, such as information on software installed in the equipment, and information on a network to which the equipment belongs. In addition, as the data of the target equipment, data in a format according to a purpose such as an Excel format or a software bill of materials (SBOM) format can be used.

When there is a change in the network to be monitored, the acquisition unit 121 acquires data of the equipment included in the network to be monitored. For example, when there is a change (such as addition, replacement and movement) in equipment included in a certain network to be monitored, the acquisition unit 121 acquires data of the equipment included in the network to be monitored.

The estimation unit 122 estimates communication destinations of the equipment using the data of the equipment acquired by the acquisition unit 121. For example, the estimation unit 122 estimates the communication destinations of the equipment using any one or a plurality of pieces of terminal information of the equipment included in the data of the equipment acquired by the acquisition unit 121 and information on software installed in the equipment. For example, the estimation unit 122 estimates that the target equipment will access FQDN to be used by company xx to distribute a security patch from the terminal information “manufactured by company xx: model number xxxx” of the equipment included in the data of the equipment acquired by the acquisition unit 121.

Furthermore, for example, the estimation unit 122 estimates that the target equipment will access FQDN to be used by company xx to distribute a pattern file from the information “company xx: anti-virus software xx” of the software installed in the equipment included in the data of the equipment acquired by the acquisition unit 121.

The collection unit 123 collects address information corresponding to the communication destinations of the equipment estimated by the estimation unit 122. For example, the collection unit 123 performs DNS inquiries using the estimated FQDN of the communication destinations of the equipment, and collects information on the estimated FQDN of the communication destinations of the equipment and the corresponding IP addresses from the analysis result obtained by capturing DNS inquiry packets and response packets.

In addition, the collection unit 123 collects address information corresponding to the communication destinations of the equipment at a predetermined cycle. For example, the collection unit 123 makes DNS inquiries to the communication destinations of the equipment every 24 hours and collects IP addresses corresponding to the FQDN of the communication destinations of the equipment. Note that the predetermined cycle at which the collection unit 123 performs collection can be changed as appropriate.

Using the data of the equipment acquired by the acquisition unit 121 and the address information Corresponding to the communication destinations of the equipment collected by the collection unit 123, the creation unit 124 creates information regarding normal communication for each network to be monitored. For example, the creation unit 124 creates a list in which the FQDN is associated with the IP addresses as information regarding normal communication. For example, the creation unit 124 creates the information on the FQDN including the communication destinations of the equipment included in the network to be monitored and the corresponding IP addresses using the information of the network to which the equipment included in the data of the equipment acquired by the acquisition unit 121 belongs and the information on the IP address corresponding to the communication destinations of the equipment collected by the collection unit 123.

The distribution unit 125 distributes the information regarding the normal communication created by the creation unit 124 to the network to be monitored. For example, the distribution unit 125 distributes the information regarding normal communication for a certain network to be monitored, created by the creation unit 124, to the notification device 200 included in the network to be monitored.

In a case where information regarding the normal communication having a difference from the information regarding the normal communication created in the past by the creation unit 124 is newly created, the distribution unit 125 distributes the newly created information regarding the normal communication to the network to be monitored. For example, in a case where information regarding normal communication including information on a combination of FQDN and an IP address that is not included in the information regarding normal communication created in the past by the creation unit 124 is newly created, the distribution unit 125 distributes the newly created information regarding normal communication to the notification device 200 included in the network to be monitored.

### [Configuration of Notification Device]

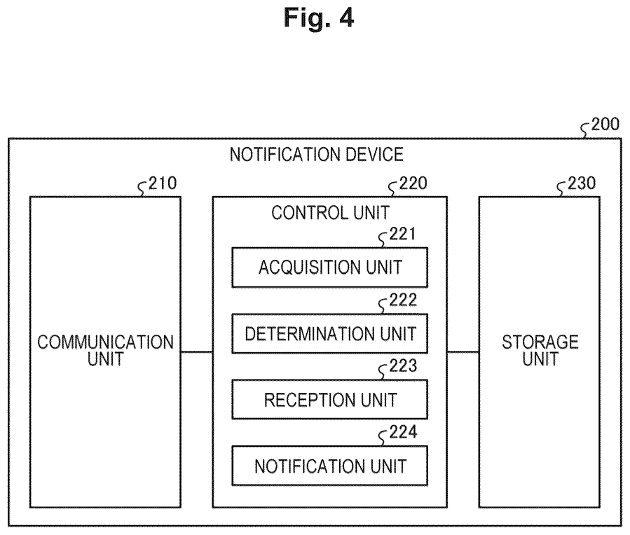

Next, a configuration of the notification device 200 will be described with reference to FIG. 4. As illustrated in FIG. 4, the notification device 200 includes a communication unit 210, a control unit 220, and a storage unit 230. Note that a plurality of devices may hold these units in a distributed manner. Hereinafter, processing by each of these units will be described.

The communication unit 210 is implemented by a network interface card (NIC), or the like, and enables communication between an external device and the control unit 220 via an electrical communication line such as a local area network (LAN) or the Internet. For example, the communication unit 210 enables communication between the external device and the control unit 220.

The storage unit 230 is implemented by a semiconductor memory element such as a random access memory (RAM) or a flash memory, or a storage device such as a hard disk or an optical disc. The information stored in the storage unit 230 includes, for example, information regarding abnormal communication, information regarding normal communication, information regarding a notification target, and other information necessary for notification of abnormal communication.

Here, the information regarding abnormal communication is detailed information of communication identified as abnormal by the external device, and includes information such as a transmission destination IP address, a transmission destination port number, a transmission source IP address, a transmission source port number, and a transmission source MAC address. Furthermore, the information regarding normal communication includes information such as FQDN of normal communication destinations and IP addresses corresponding to the FQDN of the normal communication destinations.

Furthermore, the information regarding normal communication stored in the storage unit 230 may be information distributed to each network to be monitored by the distribution device 100. Furthermore, the information regarding the notification target is information indicating the notification target, and includes information such as selection by a user and a normal communication destination list. Note that the information stored in the storage unit 230 is not limited to the examples described above.

The control unit 220 is implemented using a central processing unit (CPU), a network processor (NP), a field programmable gate array (FPGA), or the like, and executes a processing program stored in a memory. As illustrated in FIG. 4, the control unit 220 includes an acquisition unit 221, a determination unit 222, a reception unit 223, and a notification unit 224. Hereinafter, each unit included in the control unit 220 will be described.

The acquisition unit 221 acquires information regarding abnormal communication from the external device. For example, the acquisition unit 221 receives information such as a transmission destination IP address, a transmission destination port number, a transmission source IP address, a transmission source port number, and a transmission source MAC address from the abnormality detection system as the information regarding the abnormal communication.

The determination unit 222 determines whether the information regarding the abnormal communication acquired by the acquisition unit 221 corresponds to the information regarding the normal communication distributed from the distribution device 100. For example, the determination unit 222 determines whether the transmission destination IP address included in the information regarding abnormal communication acquired by the acquisition unit 221 matches an IP address corresponding to FQDN included in the information regarding normal communication distributed from the distribution device 100.

The reception unit 223 receives the information on the notification target indicating whether the information on the abnormal communication determined to correspond by determination unit 222 is the notification target. For example, the reception unit 223 receives selection by the user as the information regarding the notification target indicating whether the information regarding the abnormal communication determined to correspond by the determination unit 222 is the notification target. Note that the selection by the user includes selection as to “notification target” or “not notification target” by the user.

For example, the reception unit 223 receives selection of “not notification target” by the user as the information regarding the notification target indicating whether the information regarding the abnormal communication determined to correspond by the determination unit 222 is the notification target.

Further, for example, the reception unit 223 receives the information regarding the communication destinations as the information regarding the notification target indicating whether the information regarding the abnormal communication determined to correspond by the determination unit 222 is the notification target. Here, examples of the information regarding the communication destinations include a normal communication destination list indicating a list of normal communication destinations. For example, the reception unit 223 receives the normal communication destination list as the information regarding the notification target indicating whether the information regarding the abnormal communication determined to correspond by the determination unit 222 is the notification target.

In a case where the determination unit 222 determines that it corresponds, the notification unit 224 outputs and makes a notification of the information regarding the abnormal communication acquired by the acquisition unit 221 and the information regarding the normal communication distributed from the distribution device 100. Note that the output by the notification unit 224 includes transmission, display, and the like, of the target information. For example, in a case where the determination unit 222 determines that it corresponds, the notification unit 224 displays and makes a notification of the information regarding the abnormal communication acquired by the acquisition unit 221 and the FQDN as the information regarding the normal communication distributed from the distribution device 100 and stored in the storage unit 230.

Furthermore, for example, in a case where the determination unit 222 determines that it corresponds, the notification unit 224 displays and makes a notification of the information such as the transmission destination IP address, the transmission destination port number, the transmission source IP address, the transmission source port number, and the transmission source MAC address as the information regarding the abnormal communication acquired by the acquisition unit 221 and the FQDN as the information regarding the normal communication distributed from the distribution device 100 together.

In addition, the notification unit 224 outputs and makes a notification of the information regarding the abnormal communication acquired by the acquisition unit 221 and the information regarding the normal communication distributed from the distribution device 100 according to the information regarding the notification target received by the reception unit 223. For example, the notification unit 224 outputs and makes a notification of the information regarding the abnormal communication acquired by the acquisition unit 221 and the information regarding the normal communication distributed from the distribution device 100 according to the selection by the user received by the reception unit 223.

For example, in response to the selection of the “notification target” by the user received by the reception unit 223, the notification unit 224 displays and makes a notification of the information regarding the abnormal communication acquired by the acquisition unit 221 and the information regarding the normal communication distributed from the distribution device 100.

Furthermore, for example, the notification unit 224 outputs and makes a notification of the information regarding the abnormal communication acquired by the acquisition unit 221 and the information regarding the normal communication distributed from the distribution device 100 according to the information regarding the communication destinations received by the reception unit 223. For example, upon receiving the confirmed information regarding the communication destinations received by the reception unit 223, in a case where the information regarding the abnormal communication acquired by the acquisition unit 121 is not included in the normal communication destination list received by the reception unit 223, the notification unit 224 displays and makes a notification of the information regarding the abnormal communication acquired by the acquisition unit 221 and the information regarding the normal communication distributed from the distribution device 100.

### [Processing by Distribution Device]

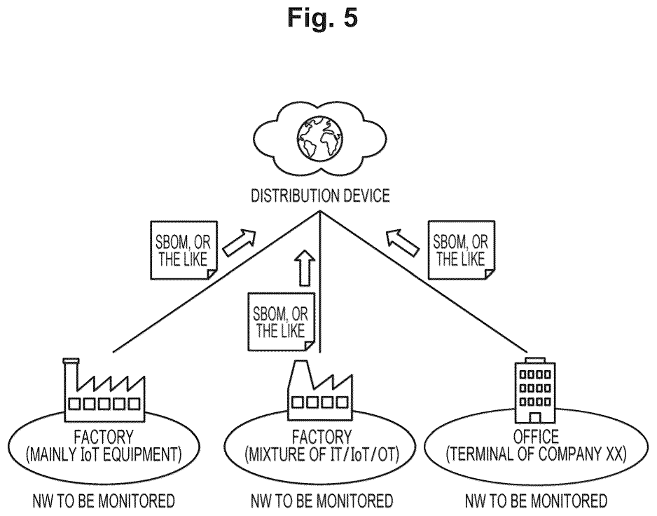

Next, processing by the distribution device 100 will be described with reference to FIGS. 5 to 7. FIGS. 5 to 7 are views for explaining outline of processing by the distribution device 100 according to the embodiment.

First, as illustrated in FIG. 5, the distribution device 100 acquires data of the equipment included in the network to be monitored. For example, the acquisition unit 121 of the distribution device 100 acquires data (such as an SBOM) of the equipment included in the network to be monitored.

Next, the estimation unit 122 of the distribution device 100 estimates FQDN of communication destinations of each kind of equipment using the acquired data of the equipment. For example, it is estimated that the “target equipment will access FQDN to be used by company xx to distribute a security patch” from the terminal information “company xx: model number xxxx” of the equipment included in the SBOM. Further, for example, it is estimated that the “target equipment will access FQDN to be used by company xx to distribute a pattern file” from the information “company xx: anti-virus software xx” of the software installed in the equipment included in the SBOM.

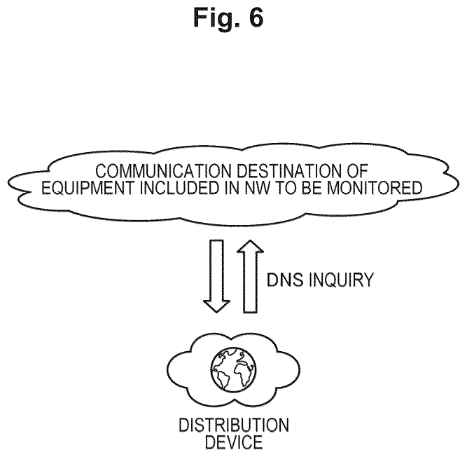

Subsequently, as illustrated in FIG. 6, the collection unit 123 of the distribution device 100 performs DNS inquiries for each kind of equipment using the estimated FQDN of the communication destinations of the equipment, and collects information on the IP addresses corresponding to the estimated FQDN of the communication destinations of the equipment. For example, the collection unit 123 of the distribution device 100 makes DNS inquiries about the estimated communication destinations of the equipment at a 24 hour cycle, and collects information on the corresponding IP addresses. Note that a timing at which the collection unit 123 of the distribution device 100 collects the information on the IP addresses corresponding to the estimated FQDN of the communication destinations of the equipment may be any timing such as a predetermined date and time or a timing linked with predetermined processing of the external system as well as at the predetermined cycle.

Thereafter, the creation unit 124 of the distribution device 100 uses the data of the equipment and the collected address information corresponding to the communication destinations of the equipment to create information regarding normal communication for each network to be monitored. For example, the creation unit 124 of the distribution device 100 creates a list in which the FQDN is associated with the IP addresses for each network to be monitored using the information on the network to which the equipment belongs included in the data of the equipment and the collected information on the IP addresses corresponding to the FQDN of the communication destinations of the equipment.

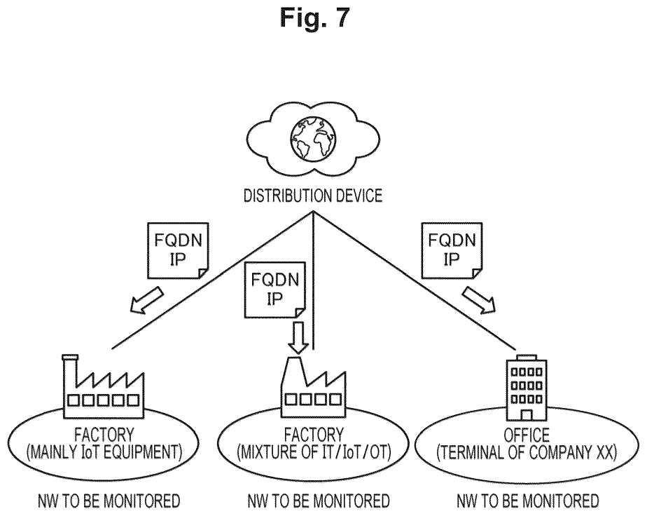

Then, as illustrated in FIG. 7, the distribution unit 125 of the distribution device 100 distributes the created information regarding normal communication to the network to be monitored. For example, in a case where information regarding normal communication having a difference from information regarding normal communication created in the past is created, the distribution unit 125 of the distribution device 100 distributes the newly created information regarding normal communication to the network to be monitored.

In other words, in a case where an IP address corresponding to the FQDN is changed and the information is collected to create a new list in which the FQDN is associated with the IP addresses, the distribution unit 125 of the distribution device 100 distributes the newly created list in which the FQDN is associated with the IP addresses to the network to be monitored.

By performing such processing, under an environment where there is a plurality of networks to be monitored, the distribution device 100 easily prepares information regarding normal communication corresponding to the networks to be monitored without considering communication destinations of equipment included in each of the networks, and always distributes the latest information to the networks to be monitored.

### [Processing by Notification Device]

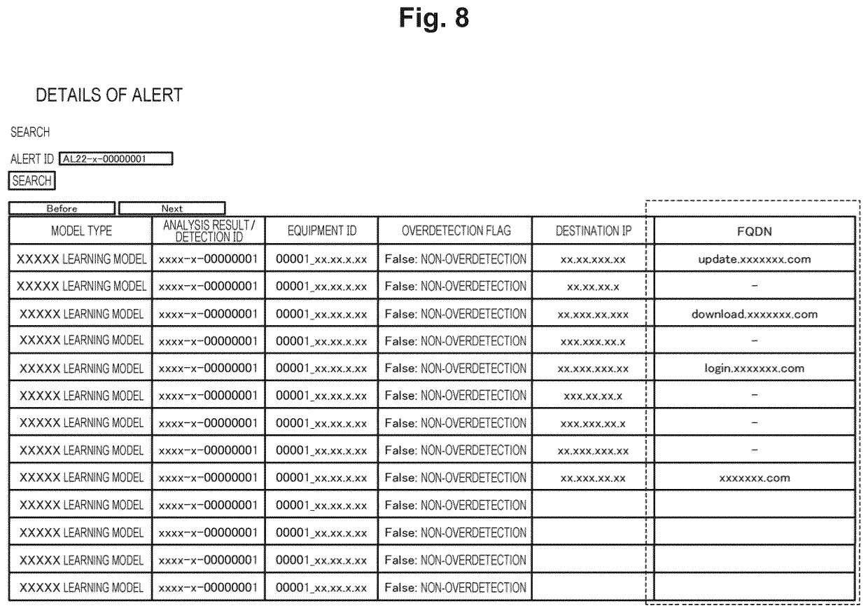

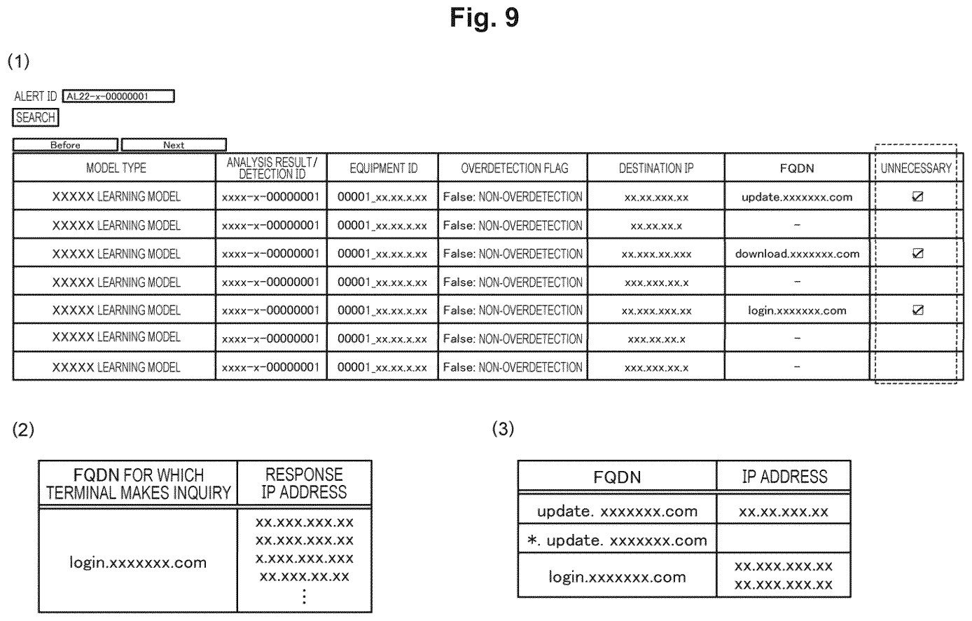

Next, processing by the notification device 200 will be described with reference to FIGS. 8 and 9. FIGS. 8 and 9 are views for explaining processing by the notification device 200 according to the embodiment.

First, the storage unit 230 of the notification device 200 stores the information regarding normal communication (a list in which the FQDN is associated with the IP addresses) distributed from the distribution unit 125 of the distribution device 100. Next, the acquisition unit 221 of the notification device 200 receives information such as a transmission destination IP address, a transmission destination port number, a transmission source IP address, a transmission source port number, and a transmission source MAC address from the abnormal communication detection system.

Subsequently, the determination unit 222 of the notification device 200 determines whether the transmission destination IP address included in the information regarding the abnormal communication acquired by the acquisition unit 221 of the notification device 200 matches an IP address corresponding to the FQDN distributed from the distribution device 100 and included in the information regarding the normal communication stored in the storage unit 230 of the notification device 200.

In this event, in a case where the information on the transmission destination IP address acquired by the acquisition unit 221 of the notification device 200 by the determination unit 222 of the notification device 200 matches the IP address corresponding to the FQDN distributed from the distribution device 100 and stored in the storage unit 230 of the notification device 200, the notification unit 224 of the notification device 200 adds the information on the FQDN corresponding to the transmission destination IP address distributed from the distribution device 100 and stored in the storage unit 230 of the notification device 200 together with the information on the transmission destination IP address, and the like, received from the abnormal communication detection system and notifies the user of the addition.

This makes it easy to determine a possibility of abnormal communication from the FQDN even in a case where a large number of alerts occur as illustrated in FIG. 8. For example, in a case of known host name or domain name, it is determined that the communication is not abnormal communication. In addition, for example, it is determined that communication to the outside by direct input of the transmission destination IP address is highly likely to be abnormal communication.

Next, notification processing by the notification device 200 will be described with reference to FIG. 9. FIG. 9 is a view for explaining processing by the notification device 200. Among them, FIG. 9(1) is an example of a detail screen of the generated alert. Furthermore, FIG. 9(2) is an example of information regarding normal communication distributed from a terminal having the function of the distribution device 100. FIG. 9(3) is an example of the normal communication destination list.

First, the reception unit 223 of the notification device 200 receives information regarding the notification target. For example, as illustrated in FIG. 9(1), the reception unit 223 of the notification device 200 receives selection of “notification is unnecessary” from the user by receiving a check mark in a field indicating unnecessary.

With this configuration, as illustrated in FIG. 9(2), the notification unit 224 of the notification device 200 does not perform notification as abnormal communication thereafter for communication in which each IP address associated with the FQDN for which the selection of “notification is unnecessary” has been received from the user is set as the transmission destination.

In addition, for example, as illustrated in FIG. 9(3), the reception unit 223 of the notification device 200 may receive, as the information regarding the communication destinations, FQDN that is found to be normal communication destinations in advance and a list of IP addresses corresponding to the FQDN (normal communication destination list).

In this way, the notification device 200 prevents occurrence of unnecessary notification using the information regarding the normal communication destination list received in advance.

### [Flowchart]

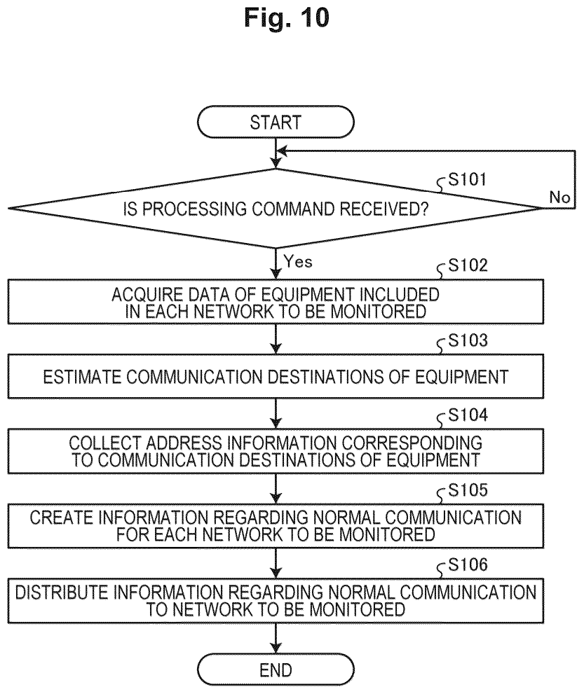

Processing flow to be performed by the distribution device 100 will be described next using FIG. 10. FIG. 10 is a flowchart indicating flow of processing by the distribution device 100. Note that the following steps may be performed in different orders, and part of the processing may be omitted.

First, the distribution device 100 determines whether or not a processing command has been received (step S101). Here, in a case where the distribution device 100 has not received the processing command (step S101: No), the distribution device 100 determines again whether or not the processing command has been received. On the other hand, in a case where the distribution device 100 has received the processing command (step S101: Yes), the distribution device 100 performs the processing of step S102 and subsequent steps.

First, the acquisition unit 121 acquires data of equipment included in the network to be monitored (step S102). For example, the acquisition unit 121 acquires, as the data of the equipment included in the network to be monitored, data of target equipment, data held in a package management system included in the target equipment, and data held in a package management system included in a configuration management system that integrally manages the target equipment.

Next, the estimation unit 122 estimates communication destinations of the equipment using the data of the equipment acquired by the acquisition unit 121 (step S103). For example, the estimation unit 122 estimates the communication destinations of the equipment using any one or a plurality of pieces of terminal information of the equipment included in the data of the equipment acquired by the acquisition unit 121 and information on software installed in the equipment.

Then, the collection unit 123 collects the address information corresponding to the communication destinations of the equipment estimated by the estimation unit 122 (step S104). For example, the collection unit 123 performs DNS inquiries using the estimated FQDN of the communication destinations of the equipment, and collects information on the estimated FQDN of the communication destinations of the equipment and the corresponding IP addresses from the analysis result obtained by capturing DNS inquiry packets and response packets.

Thereafter, the creation unit 124 creates information regarding normal communication for each network to be monitored using the data of the equipment acquired by the acquisition unit 121 and the address information corresponding to the communication destinations of the equipment collected by the collection unit 123 (step S105). For example, the creation unit 124 creates a list in which the FQDN is associated with the IP addresses as information regarding normal communication.

Then, the distribution unit 125 distributes the information regarding the normal communication created by the creation unit 124 to the network to be monitored (step S106). For example, the distribution unit 125 distributes the information regarding normal communication for a certain network to be monitored, created by the creation unit 124, to the notification device 200 included in the network to be monitored.

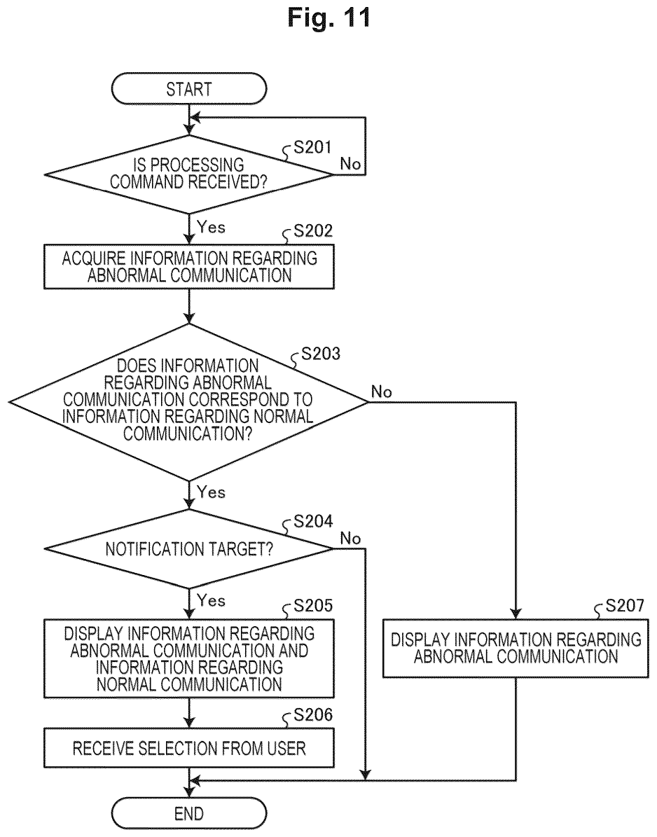

Next, flow of processing by the notification device 200 will be described with reference to FIG. 11. FIG. 11 is a flowchart indicating flow of processing by the notification device 200. Note that the following steps may be performed in different orders, and part of the processing may be omitted.

First, the notification device 200 determines whether or not a processing command has been received (step S201). Here, in a case where the notification device 200 has not received the processing command (step S201: No), the notification device 200 determines again whether or not the processing command has been received. On the other hand, in a case where the distribution device 100 has received the processing command (step S201: Yes), the distribution device 100 performs the processing of step S202 and subsequent steps.

Next, the acquisition unit 221 acquires information regarding abnormal communication from an external device (step S202). For example, the acquisition unit 121 receives, from the abnormal communication detection system, information such as a transmission destination IP address, a transmission destination port number, a transmission source IP address, a transmission source port number, and a transmission source MAC address as the information regarding the abnormal communication.

Then, the determination unit 222 determines whether the information regarding the abnormal communication acquired by the acquisition unit 221 corresponds to the information regarding the normal communication distributed from the distribution device 100 (step S203). For example, the determination unit 222 determines whether the transmission destination IP address included in the information regarding the abnormal communication acquired by the acquisition unit 221 matches an IP address corresponding to FQDN distributed from the distribution device 100 and included in the information regarding the normal communication stored in the storage unit 230.

In a case where the determination unit 222 determines that the information regarding the abnormal communication corresponds to the information regarding the normal communication distributed from the distribution device 100 (step S203: Yes), the notification unit 224 determines whether the information regarding the abnormal communication determined to correspond by determination unit 222 is a notification target (step S204).

Here, in a case where the notification unit 224 determines that the information regarding the abnormal communication determined to correspond by the determination unit 222 is the notification target (step S204: Yes), the notification unit 224 outputs and makes a notification of the information regarding the abnormal communication acquired by the acquisition unit 221 and the information regarding the normal communication distributed from the distribution device 100 and stored in the storage unit 230 according to the information regarding the notification target received by the reception unit 223 (step S205).

For example, the notification unit 224 displays and makes a notification of the information regarding the abnormal communication acquired by the acquisition unit 221 and the FQDN as the information regarding the normal communication distributed from the distribution device 100 and stored in the storage unit 230 according to the selection by the user received by the reception unit 223.

Thereafter, the reception unit 223 receives information regarding a notification target indicating whether the information regarding the abnormal communication determined to correspond by the determination unit 222 is the notification target (step S206). For example, the reception unit 223 receives selection by the user as the information regarding the notification target indicating whether the information regarding the abnormal communication determined to correspond by the determination unit 222 is the notification target.

On the other hand, in step S203, in a case where the notification unit 224 determines that the information regarding the abnormal communication determined to correspond by the determination unit 222 is not the notification target (step S204: No), the notification unit 224 does not make a notification.

On the other hand, in a case where the determination unit 222 determines in step S203 that the information regarding the abnormal communication does not correspond to the information regarding the normal communication (step S203: No), the notification unit 224 outputs and makes a notification of the information regarding the abnormal communication (step S207). For example, the notification unit 224 outputs and makes a notification of information such as a transmission destination IP address, a transmission destination port number, a transmission source IP address, a transmission source port number, and a transmission source MAC address as the information regarding the abnormal communication.

### [Effects]

The distribution device 100 according to the embodiment includes the acquisition unit 121 that acquires data of equipment included in a network to be monitored, the estimation unit 122 that estimates communication destinations of the equipment using the data of the equipment acquired by the acquisition unit 121, the collection unit 123 that collects address information corresponding to the communication destinations of the equipment estimated by the estimation unit 122, the creation unit 124 that creates information regarding normal communication for each network to be monitored using the data of the equipment acquired by the acquisition unit 121 and the address information corresponding to the communication destinations of the equipment collected by the collection unit 123, and the distribution unit 125 that distributes the information regarding the normal communication created by the creation unit 124 to the network to be monitored.

As a result, the distribution device 100 can easily prepare the information regarding the normal communication corresponding to the network to be monitored by collecting the address information corresponding to the communication destinations of the equipment estimated from the data of the equipment included in the network to be monitored and creating and distributing the information regarding the normal communication.

Furthermore, the distribution device 100 can prepare the information regarding the normal communication for each network to be monitored. For example, the distribution device 100 creates a list of FQDN and IP addresses as a master list and distributes the master list to the network to be monitored, which enables efficient operation of the abnormal communication detection system in a plurality of networks to be monitored.

In addition, the distribution device 100 can efficiently detect abnormal communication while preventing overdetection even in a network in which various kinds of equipment are mixed by grasping equipment and software configurations that are being used in the network to be monitored and distributing a list of FQDN and IP addresses corresponding to the network.

In addition, the estimation unit 122 of the distribution device 100 according to the embodiment estimates the communication destinations of the equipment using any one or a plurality of pieces of terminal information of the equipment included in the data of the equipment and information on software installed in the equipment.

This enables the distribution device 100 to easily prepare the information regarding the normal communication Corresponding to the network to be monitored by collecting the terminal information included in the data of the equipment included in the network to be monitored and the address information corresponding to the communication destinations of the equipment estimated from the information of the installed software and creating and distributing the information regarding the normal communication.

In addition, the acquisition unit 121 of the distribution device 100 according to the embodiment acquires the data of the equipment included in the network to be monitored in a case where there is a change in the network to be monitored.

This enables the distribution device 100 to easily prepare the information regarding the normal communication corresponding to the network to be monitored by acquiring the data of the equipment at the time of change of the network to be monitored, collecting the address information corresponding to the communication destinations of the equipment estimated from the data of the equipment and creating and distributing the information regarding the normal communication.

In addition, the collection unit 123 of the distribution device 100 according to the embodiment collects the address information corresponding to the communication destinations of the equipment at a predetermined cycle.

This enables the distribution device 100 to easily prepare the information regarding the normal communication corresponding to the network to be monitored by acquiring data of the equipment included in the network to be monitored, collecting address information corresponding to the communication destinations of the equipment estimated from the data of the equipment at a predetermined cycle and creating and distributing the information regarding the normal communication.

Furthermore, in a case where information regarding normal communication having a difference from the information regarding the normal communication created in the past by the creation unit 124 is newly created, the distribution unit 125 of the distribution device 100 according to the embodiment distributes the newly created information regarding the normal communication to the network to be monitored.

This enables the distribution device 100 to, in a case where information regarding different normal communication is newly created, distribute the newly created information regarding the normal communication to the network to be monitored. In other words, by automatically distributing an update result of the master list of the FQDN and the IP addresses to the network to be monitored, it is possible to operate a plurality of abnormal communication detection systems always by the latest list of the FQDN and the IP addresses without trouble.

Furthermore, the creation unit 124 of the distribution device 100 according to the embodiment creates a list in which the FQDN is associated with IP addresses as the information regarding the normal communication.

This enables the distribution device 100 to easily prepare the information regarding the normal communication corresponding to the network to be monitored by collecting the IP addresses corresponding to the FQDN of the communication destinations of the equipment estimated from the data of the equipment included in the network to be monitored and creating and distributing the information regarding the normal communication.

Further, the abnormality notification system 1 according to the embodiment includes the distribution device 100 that distributes information regarding normal communication to a plurality of networks to be monitored, and the notification device 200 that makes a notification of abnormal communication of each of the networks to be monitored. The distribution device 100 includes the acquisition unit 121 that acquires data of equipment included in the networks to be monitored, the estimation unit 122 that estimates communication destinations of the equipment from the data of the equipment acquired by the acquisition unit 121, the collection unit 123 that collects address information corresponding to the communication destinations of the equipment estimated by the estimation unit 122, the creation unit 124 that creates the information regarding the normal communication for each of the networks to be monitored using the data of the equipment acquired by the acquisition unit 121 and the address information corresponding to the communication destinations of the equipment collected by the collection unit 123, and the distribution unit 125 that distributes the information regarding the normal communication created by the creation unit 124 to the networks to be monitored, and the notification device 200 includes the acquisition unit 221 that acquires information regarding abnormal communication from an external device, the determination unit 222 that determines whether the information regarding the abnormal communication acquired by the acquisition unit 221 corresponds to the information regarding the normal communication distributed from the distribution device 100, and the notification unit 224 that outputs and makes a notification of the information regarding the abnormal communication acquired by the acquisition unit 221 and the information regarding the normal communication distributed from the distribution device 100 in a case where the determination unit 222 determines that it corresponds.

This enables the distribution device 100 of the abnormality notification system 1 to accurately determine abnormal communication by creating and distributing the information regarding the normal communication, and the notification device 200 determining whether or not the information regarding the abnormal communication corresponds to the information regarding the normal communication stored in advance, and outputting and making a notification of the information regarding the normal communication in a case where the information regarding the abnormal communication corresponds to the information regarding the normal communication. In other words, the distribution device 100 and the notification device 200 included in the abnormality notification system 1 operate in cooperation, so that it is possible to prevent an alert from being generated due to overdetection.

### [Program]

It is also possible to create a program in which the processing to be executed by the distribution device 100 described in the above embodiment is described in a Language executable by a computer. In this case, the computer executes the program, and thus effects similar to those of the above-described embodiment can be obtained. Further, such a program may be recorded in a computer-readable recording medium, and the program recorded in the recording medium may be read and executed by a computer to implement a process similar to the above-described embodiment.

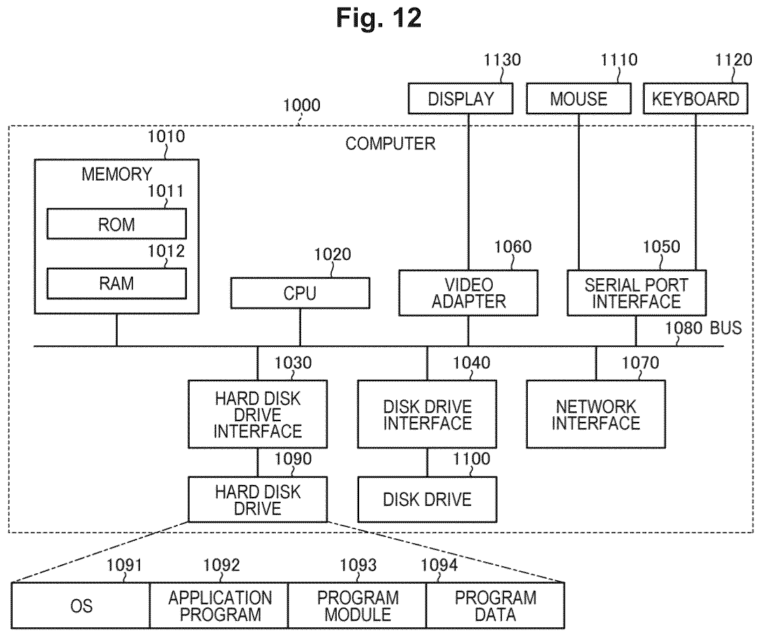

FIG. 12 is a view illustrating an example of the computer that executes a distribution program. As illustrated in FIG. 12, a computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disc or an optical disc is inserted into the disk drive 1100. For example, a mouse 1110 and a keyboard 1120 are connected to the serial port interface 1050. For example, a display 1130 is connected to the video adapter 1060.

Here, as illustrated in FIG. 12, the hard disk drive 1090 stores, for example, an OS 1091, an application program 1092, a program module 1093, and program data 1094. Each table described in the above embodiments is stored in, for example, the hard disk drive 1090 or the memory 1010.

In addition, the distribution program is stored in the hard disk drive 1090 as, for example, a program module in which a command to be executed by the computer 1000 is described. Specifically, the program module 1093 in which each piece of processing to be executed by the computer 1000 described in the above-described embodiment is described is stored in the hard disk drive 1090.

In addition, data to be used for information processing by the distribution program is stored, for example, in the hard disk drive 1090 as program data. Then, the CPU 1020 reads the program module 1093 and the program data 1094 stored in the hard disk drive 1090 to the RAM 1012 as necessary, and executes each procedure described above.

Note that the program module 1093 and the program data 1094 related to the distribution program are not limited to being stored in the hard disk drive 1090, and may be stored in, for example, a removable storage medium and read by the CPU 1020 via the disk drive 1100, or the like. Alternatively, the program module 1093 and the program data 1094 related to the control program may be stored in another computer connected via a network such as a local area network (LAN) or a wide area network (WAN) and may be read by the CPU 1020 via the network interface 1070.

### [Others]

Although various embodiments have been described in detail in the present specification with reference to the drawings, these embodiments are merely examples and are not intended to limit the present invention to these embodiments. The features described in the present specification may be achieved by various methods, including various modifications and improvements based on the knowledge of those skilled in the art.

Furthermore, each “module”, each suffix “-er”, and each suffix “-or” in the above description can be read as a unit, a means, a circuit, or the like. For example, a communication module, a control module, and a storage module may be interchangeable with a communication unit, a control unit, and a storage unit, respectively.

### REFERENCE SIGNS LIST

1 Abnormality notification system
100 Distribution device
110 Communication unit
120 Control unit
121 Acquisition unit
122 Estimation unit
123 Collection unit
124 Creation unit
125 Distribution unit
130 Storage unit
200 Notification device
210 Communication unit
220 Control unit
221 Acquisition unit
222 Determination unit
223 Reception unit
224 Notification unit
230 Storage unit

1. A distribution device comprising:
a memory; and
processing circuitry configured to:
acquire data of equipment included in a network to be monitored;
estimate communication destinations of the equipment using the data of the equipment acquired;
collect address information corresponding to the communication destinations of the equipment estimated;
create information regarding normal communication for each network to be monitored using the data of the equipment acquired and the address information corresponding to the communication destinations of the equipment collected; and
distribute the information regarding the normal communication created to the network to be monitored.

2. The distribution device according to claim 1, wherein the processing circuitry is further configured to:
estimate the communication destinations of the equipment using any one or a plurality of pieces of terminal information of the equipment included in the data of the equipment and information on software installed in the equipment.

3. The distribution device according to claim 1, wherein the processing circuitry is further configured to:
acquire the data of the equipment included in the network to be monitored in a case where there is a change in the network to be monitored.

4. The distribution device according to claim 1, wherein the processing circuitry is further configured to:
collect the address information corresponding to the communication destinations of the equipment at a predetermined cycle.

5. The distribution device according to claim 1, wherein in a case where information regarding normal communication having a difference from the information regarding the normal communication created in past is newly created, the processing circuitry is further configured to:
distribute the newly created information regarding the normal communication to the network to be monitored.

6. The distribution device according to claim 1, wherein the processing circuitry is further configured to:
create a list in which FQDN is associated with IP addresses as the information regarding the normal communication.

7. A non-transitory computer-readable recording medium storing therein a distribution program causing a computer to execute a process comprising:
acquiring data of equipment included in a network to be monitored;
estimating communication destinations of the equipment from the data of the equipment acquired in the acquisition step;
collecting address information corresponding to the communication destinations of the equipment estimated;
creating information regarding normal communication for each network to be monitored using the data of the equipment acquired and the address information corresponding to the communication destinations of the equipment collected; and
distributing the information regarding the normal communication created to the network to be monitored.

8. An abnormality notification system comprising:
a distribution device that distributes information regarding normal communication to a plurality of networks to be monitored; and
a notification device that makes a notification of abnormal communication of each of the networks to be monitored, wherein
the distribution device comprising:
a memory; and
processing circuitry configured to:
acquire data of equipment included in the networks to be monitored;
estimate communication destinations of the equipment from the data of the equipment acquired;
collect address information corresponding to the communication destinations of the equipment estimated;
create information regarding normal communication for each of the networks to be monitored using the data of the equipment acquired and the address information corresponding to the communication destinations of the equipment collected; and
distribute the information regarding the normal communication created to the networks to be monitored,
and
the notification device comprising:
a memory; and
processing circuitry configured to:
acquire information regarding abnormal communication from an external device;
determine whether the information regarding the abnormal communication acquired corresponds to the information regarding the normal communication distributed from the distribution devices; and
output and makes a notification of the information regarding the abnormal communication acquired and the information regarding the normal communication distributed from the distribution device in a case where determining that it corresponds.
